(19) United States
(12) Patent Application Publication
(10) Pub. No.: US 2004/0157143 A1
(43) Pub. Date: Aug. 12, 2004

(54) Exposure method and lithography system, exposure apparatus and method of making the apparatus, and method of manufacturing device

(75) Inventor: Tetsuo Taniguchi, Ageo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nikon Corporation, Chiyoda-ku (JP)

(21) Appl. No.: 10/773,293

(22) Filed: Feb. 9, 2004

Related U.S. Application Data
(63) Continuation of application No. 09/618,550, filed on Jul. 17, 2000, now abandoned.
Application No. 09/618,550 is a continuation of application No. PCT/JP99/00122, filed on Jan. 18, 1999.

(30) Foreign Application Priority Data
Jan. 16, 1998 (JP) 10-020479

(51) Int. Cl. G03B 27/00; G03C 5/00

(52) U.S. Cl. 430/30; 355/18

(57) ABSTRACT

Based on the information about the capability of a first exposure apparatus of correcting the distortion of a first mask transferred a wafer, the image forming characteristics of a second exposure apparatus is adjusted. Therefore, image forming characteristics can be appropriately adjusted (decreasing the correction residual error), considering the distortion of the pattern image of the first mask transferred onto the wafer by the first exposure apparatus. That is, in order to properly transfer the pattern of a second mask onto the wafer by using the second exposure apparatus, the image forming characteristics of the second exposure apparatus are so adjusted that the distortion of the image of the pattern of the second mask is almost the same of that of the first mask. Hence, good image registration is realized.

### CROSS-REFERENCE TO RELATED APPLICATIONS

This is a continuation of International Application PCT/JP99/00122, with an international filing date of Jan. 18, 1999, the entire content of which is hereby incorporated by reference.

### BACKGROUND OF THE INVENTION

1. FIELD OF THE INVENTION

The present invention relates to an exposure method and lithography system, an exposure apparatus and the method of making the apparatus, and a method of manufacturing devices. More particularly, this invention relates to an exposure method and a lithography system used in lithographic processes for manufacturing micro devices such as semiconductor devices or liquid-crystal display devices, an exposure apparatus and the method of making the apparatus, the exposure apparatus constituting the lithography system, and a method for manufacturing micro devices using the exposure method and lithography system.

2. DESCRIPTION OF THE RELATED ART

In lithographic processes for manufacturing micro devices such as semiconductor devices or liquid-crystal display devices, various kinds of exposure apparatus have been conventionally used. In particular, for example, a reduction image projection exposure apparatus (often referred to simply as a stepper) employing the step-and-repeat method has been mainly used. However, in recent years, as integrated circuits or the like have become highly integrated, a scanning type exposure apparatus which allows an exposure with higher accuracy than the stepper and employs the so-called step-and-scanning method has been developed and is becoming mainstream. The scanning type exposure apparatus illuminates a mask or a reticle (hereinafter referred to as a “reticle” in general) with illuminating light flux of which a cross-section is rectangular or arcuated. The exposure apparatus scans synchronously a substrate such as a reticle and a wafer in a linear direction against the projection optical system and thereby transfers the reticle pattern onto the substrate in sequence via the projection optical system.

Such a scanning type exposure apparatus allows transferring reticle patterns, using only a portion (the center portion) of the effective exposure field of the projection optical system with minimum aberration. Accordingly, compared with the stationary type exposure apparatus such as the stepper mentioned above, the scanning type exposure apparatus allows the transfer of finer patterns with higher accuracy. In addition, the scanning type exposure apparatus can expand the exposure field without being limited by the projection optical system in the scanning direction, thereby enabling exposure of a large area. Furthermore, the scanning type exposure apparatus has an averaging effect resulting from relative scanning of a reticle and a wafer against the projection optical system, and thus has a merit in that it can reduce distortion and improve the depth of focus.

In the case of manufacturing semiconductor devices, it is necessary to deposit different circuit patterns on plurality of layers on a substrate. Thus, it is important to overlay accurately a reticle where a circuit pattern is fabricated, with a pattern that has already been formed in each shot area of the substrate. That is, the overlay accuracy is essential. For example, when the circuit pattern of each layer on one substrate is formed with different projection exposure apparatus, different distortions between projection images of the exposure apparatus would cause an error in overlay. Thus, the matching of image distortions of the projection optical systems between the projection exposure apparatus is also one of the items that greatly affect the overlay accuracy. Conventionally, such a method has been suggested so as to perform exposure by the exposure apparatus which positively generates a distortion in its projection image to match with the distortion of the pattern in existing layers of the substrate in order to improve the overlay accuracy. With the stepper mentioned earlier, a method of generating an image distortion by moving one or more of the lens elements of the projection optical system in the direction of the optical axis or by tilting the one or more lens elements against a plane perpendicular to the optical axis, is disclosed in, for example, Japan Patent Laid-Open No. 04-127514. In addition, in the case of the scanning type exposure apparatus, for example, a method of distorting a formed image by changing the magnification of the projection optical system in sequence during the scanning exposure, by creating an offset in the relative angle between the scanning directions of the reticle and the substrate, or by changing the above relative angle in sequence, is disclosed in, for example, Japan Patent Laid-Open No. 07-57991.

In the conventional methods, as stated above, however, image distortion components that cannot be corrected still exist, leading to a correction residual error. For example, the stationary type exposure apparatus can move lens elements in the direction of the optical axis in accordance with the distortion of the pattern image that should be overlaid, thus making it easy to change the magnification and generate an image distortion component symmetrical with respect to the optical axis such as a symmetrical distortion component. It is also easy to generate a trapezoidal distortion by tilting optical elements.

In the case, however, where a distortion component other than these components is included in the pattern image that should be overlaid, it is difficult (or impossible) to generate an image distortion in accordance with the distortion component of the pattern image. For example, it is difficult to generate a distortion component from a square, which distorts into a rectangle or a parallelogram.

On the other hand, with the scanning type exposure apparatus, an image is formed after the relative scanning of the reticle and the substrate. Thus, it is relatively easy to generate an image distortion such as a rectangular component and parallelogrammatic component by respectively changing the synchronous velocity ratio and the angle between the scanning directions of the reticle and the substrate. It is, however, extremely difficult (or impossible) to generate an axially symmetrical image distortion component. That is, for example, as shown in FIG. 6 of Japan Patent Laid-Open No. 07-57991, a trapezoidal component can be approximately generated by gradually changing the width of a slit-shaped illumination area in a non-scanning direction during scanning exposure. However, a desired trapezoidal component cannot be generated due to the limit in control response of the image forming correction mechanism. Moreover, generating an approximate trapezoidal component would require very complicated control. Likewise, as for other axially symmetrical image distortion components, such as a pincushion distortion component, a desired pincushion distortion component cannot be generated. Moreover, generating an approximate pincushion distortion component would require very complicated control.

### SUMMARY OF THE INVENTION

The present invention has been made in consideration of such circumstances and has as its first object to provide a lithography system and an exposure method to improve overlay accuracy during exposure.

It is the second object of the present invention to provide a device manufacturing method to improve the productivity of highly integrated micro devices.

If information about the image distortion correction capability of an exposure apparatus that has performed exposure of a previous layer can be used by a exposure apparatus that is to be used for exposure of a subsequent layer, and/or informing about the image distortion correction capability of the exposure apparatus for the subsequent layer can be used by the exposure apparatus for the previous layer when a plurality of exposure apparatus are used to form patterns of a plurality of layers one above another on the substrate, it is conceivable that a final residual error in correction can be made smaller in accordance with the image distortion correction capability of the counterpart exposure apparatus and the overlay accuracy can be improved consequently. The present invention was developed in view of such a point.

In the first aspect of the present invention, there is provided a first exposure method of forming patterns of a plurality of layers on a substrate using a plurality of exposure apparatus which comprises adjusting an image forming characteristic of a first exposure apparatus in the plurality of exposure apparatus to expose one layer in consideration of image distortion correction capability of a second exposure apparatus which is different from the first exposure apparatus, and exposing another layer by using the second exposure apparatus.

In this method, an image forming characteristic of an exposure apparatus in the plurality of exposure apparatus is adjusted to perform exposure for a layer in consideration of image distortion correction capability of another exposure apparatus to be used for another layer. Accordingly, in the case where a plurality of patterns are exposed one above another on the substrate, it becomes possible to improve the overlay accuracy of an exposure in between, at least, a layer exposed by the exposure apparatus mentioned above, and the layer exposed by the exposure apparatus which image distortion correction capability has been considered. This first exposure method is effective especially when one exposure apparatus of a plurality of exposure apparatus has a different image distortion correction capability and the remaining exposure apparatus have a similar image distortion correction capability. In such a case, consequently, it becomes possible to improve the overlay accuracy of the pattern of all layers.

In the first exposure method of the present invention, in the plurality of exposure apparatus, the first apparatus can be one of a stationary type exposure apparatus in which a mask and the substrate are almost stationary during exposure and a scanning type exposure apparatus in which a mask and the substrate are synchronously moved during exposure, and the second apparatus can be the other of the stationary type exposure apparatus and the scanning type exposure apparatus. The first exposure method can further comprise adjusting an image forming characteristic of the second exposure apparatus in consideration of image distortion correction capability of the first exposure apparatus.

In the first exposure method of the present invention, the first exposure apparatus and the second exposure apparatus are used in the exposure of layers in sequence. In this case, the patterns are respectively transferred in sequence, and it becomes possible to improve the overlay accuracy between the patterns that are formed on the substrate.

In this case, the first apparatus can be one of a stationary type exposure apparatus in which a mask and the substrate are almost stationary during exposure and a scanning type exposure apparatus in which a mask and the substrate are synchronously moved during exposure, and the second apparatus can be the other of the stationary type exposure apparatus and the scanning type exposure apparatus.

In the second aspect of the present invention, there is provided a second exposure method of transferring a pattern of a second mask onto a substrate using a second exposure apparatus after transferring a pattern of a first mask onto the substrate using a first exposure apparatus in which the method comprises adjusting an image forming characteristic of the second exposure apparatus, in consideration of an image distortion which is difficult or impossible to correct for said first exposure apparatus, and exposing the substrate to transfer the pattern of the second mask by using the second exposure apparatus.

According to this method, the pattern of the second mask is transferred onto the substrate with the image forming characteristics of the second exposure apparatus being adjusted in consideration of the image distortion which is corrected with difficulty (or cannot be corrected) with the first exposure apparatus which transferred the pattern of the first mask onto the substrate. Therefore, the transferring of the pattern of the second mask is performed with the image forming characteristics of the second exposure apparatus adjusted so that it positively generates the image distortion that is corrected with difficulty (or cannot be corrected) by the first exposure apparatus. It, therefore, becomes possible to improve the overlay accuracy to an extent of almost no correction residual error.

In the a third aspect of the present invention, there is provided a third exposure method of transferring a pattern of a first mask onto a substrate using a first exposure apparatus before transferring a pattern of a second mask onto the substrate using a second exposure apparatus, in which the method comprises adjusting an image forming characteristic of the first exposure apparatus, in consideration of an image distortion which is difficult or impossible to be corrected by the second exposure apparatus, and exposing the substrate to transfer the pattern of the first mask by using the first exposure apparatus.

According to this method, the pattern of the first mask is transferred onto the substrate with the image forming characteristics of the first exposure apparatus adjusted in consideration of the image distortion that is corrected with difficulty (or cannot be corrected) by the second exposure apparatus which is to be used for transferring the pattern of the second mask on the subsequent layer. It, therefore, becomes possible to transfer the pattern of the first mask onto the substrate by adjusting the image forming characteristics of the first exposure apparatus so that the image distortion that is corrected with difficulty (or cannot be corrected) by the second exposure apparatus does not remain. The second exposure apparatus can transfer the pattern of the second mask on top of the image of the first mask pattern with its image distortion generated, so that it matches the image of the first mask that has been transferred onto the substrate.

In such case, the second exposure apparatus is preferred to be a scanning type exposure apparatus which moves the mask and the substrate synchronously during exposure, and the image forming characteristic of the first exposure apparatus is adjusted so as to reduce an axially symmetrical image distortion component which is difficult or impossible to be corrected by the scanning type exposure apparatus. In addition, in such case that the second exposure apparatus is a stationary type exposure apparatus in which the mask and the substrate are almost stationary during exposure, it is preferred that the image forming characteristic of the first exposure apparatus is adjusted so as to reduce an image distortion including a rectangular component and parallelogrammatic component, which is difficult or impossible to be corrected by the stationary type exposure apparatus.

In the fourth aspect of the present invention, there is provided a fourth exposure method of transferring a pattern of a first mask onto a substrate using a first exposure apparatus, and of further transferring a pattern of a second mask onto the substrate using a second exposure apparatus, in which the method comprises adjusting an image forming characteristic of the first exposure apparatus, in accordance with information on an image distortion correction capability of the second exposure apparatus, and transferring said pattern of the first mask onto the substrate.

According to this method, the pattern of the first mask is transferred onto the substrate with the image forming characteristics of the first exposure apparatus adjusted, in accordance with the image distortion correction capability of the second exposure apparatus to be used in the exposure of a subsequent layer which transfers the pattern of the second exposure apparatus onto the substrate. It, therefore, simplifies the adjustment of the image forming characteristics of the second exposure apparatus.

In this case, it is preferred that the image forming characteristic of the first exposure apparatus is adjusted so as to reduce an image distortion which is difficult or impossible to be corrected by the second exposure apparatus. In such case, the first exposure apparatus transfers the pattern of the first mask onto the substrate, with at least the image distortion the second exposure apparatus corrects with difficulty being corrected. Therefore, it becomes possible to simplify the adjustment of the image forming characteristics of the second exposure apparatus, as well as reduce the correction residual error so as increase the accuracy of adjustment.

In the fifth aspect of the present invention, there is provided a fifth exposure method of transferring a pattern of a first mask onto a substrate(W) using a first exposure apparatus, and of further transferring a pattern of a second mask onto the substrate using a second exposure apparatus, in which the method comprises adjusting an image forming characteristic of the first exposure apparatus, so as to leave an image distortion which the second exposure apparatus can correct, and transferring the pattern of the first mask onto the substrate.

According to this method, the pattern of the first mask is transferred onto the substrate with the image forming characteristics of the first exposure apparatus being adjusted so that the image distortion that is easily corrected (or can be corrected) by the second exposure apparatus which is to transfer the pattern of the second mask onto the subsequent layer remains. The second exposure apparatus can, therefore, transfer the pattern of the second mask in sequence onto the image of the first mask pattern with an image distortion being generated so that the overlay almost matches the pattern of the first mask that has been transferred onto the substrate.

In this case, it is preferred that the second exposure apparatus is a scanning type exposure apparatus which moves the mask and the substrate synchronously during exposure, and the image forming characteristic of the first exposure apparatus is adjusted so as to leave at least one of image distortion components of a rectangular component and a parallelogrammatic component, which can be corrected by the scanning type exposure apparatus. In addition, in the case the second exposure apparatus is a stationary type exposure apparatus in which the mask and the substrate are almost stationary during exposure, it is preferred that the image forming characteristic of the first exposure apparatus is adjusted so as to leave at least one of image distortion components of a trapezoidal component and an axially symmetrical component, which can be corrected by the stationary type exposure apparatus.

In the a sixth aspect of the present invention, there is provided a sixth exposure method of forming patterns of a plurality of layers on a substrate using a plurality of exposure apparatus, which comprises transferring a pattern of a first mask onto the substrate using a first exposure apparatus, adjusting an image forming characteristic of a second exposure apparatus, in accordance with the information on image distortion correction capability of the first exposure apparatus, and further transferring a pattern of a second mask onto an area on the substrate where the pattern of the first mask is formed, using the second exposure apparatus of which the image forming characteristic has already been adjusted.

In this method, in accordance with the information on the image distortion correction capability of the first exposure apparatus which transfers the pattern of the first mask onto the substrate, the image forming characteristics of the second exposure apparatus is then adjusted in accordance with the information about the image distortion correction capability of the first exposure apparatus. This makes appropriate adjustment (decreasing the correction residual error) possible, in which the image forming characteristics of the second exposure apparatus is adjusted considering the image distortion of the first mask pattern transferred by the first exposure apparatus. That is, in the case when the pattern of the second mask is transferred onto the substrate using the second exposure apparatus which image forming characteristics have been adjusted, the image forming characteristics of the second exposure apparatus can be adjusted so that the image distortion of the pattern of the second mask almost matches the pattern of the first mask. Thus, it becomes possible to achieve good overlay with almost no correction residual error by transferring the pattern of the second mask onto the area where the transferred pattern of the first mask has been formed.

In this case, the image forming characteristic of the second exposure apparatus can be adjusted, further in consideration of information about a shape of a shot area on the substrate, the shape being measured prior to exposure.

In the sixth exposure method according to the present invention, it is preferred that the transferring of the pattern of the first mask is performed in a manner that the pattern of the first mask is transferred onto the substrate with an adjustment of an image forming characteristic of the first exposure apparatus in accordance with image distortion correction capability of the second exposure apparatus. In such a case, the pattern of the first mask is transferred onto the substrate with the image forming characteristics of the first exposure apparatus adjusted in accordance with the image distortion correction capability of the second exposure apparatus to be used for exposure of the subsequent layer. Thus, this simplifies the adjustment of the image forming characteristics of the second exposure apparatus.

Furthermore, in the sixth exposure method according to the present invention, it is preferred that transferring a pattern of a first mask is performed in a manner that the pattern of the first mask is transferred with a correction of an image distortion component which is difficult or impossible to be corrected by the second exposure apparatus. In such case the pattern of the first mask is transferred onto the substrate with at least the image distortion difficult to correct with the second exposure apparatus corrected. Therefore, the image forming characteristics of the second exposure apparatus can be adjusted simply and accurately so as to minimize correction residual error.

Still furthermore, in the sixth exposure method according to the present invention, one of the first and second exposure apparatus is a stationary type exposure apparatus in which the mask and the substrate are almost stationary during exposure, and the other of the first and second exposure apparatus can be a scanning type exposure apparatus in which the mask and the substrate are moved synchronously during exposure. In this case, it is preferred that each of the first and second exposure apparatus respectively corrects image distortion component which can be corrected. As described above, since the scanning type exposure apparatus and the stationary exposure type exposure apparatus correct different types of image distortions, it becomes possible to improve overlay accuracy by each exposure apparatus correcting image distortions that can easily be corrected by itself, even if the exposure apparatus cannot generate ideal shapes of distortion after correction. In other words, the image distortion which one exposure apparatus has difficulty to correct can be easily corrected by the other exposure apparatus. The exposure apparatus can leave the image distortion difficult to corrected to the other apparatus, covering up the drawbacks of the other. In addition, in the case a component which can be corrected by the other apparatus becomes large, the result of the overlay is more accurate when the component which cannot be correct by the other apparatus is reduced.

In this case, the image distortion component which can be corrected includes at least one of a rectangular component and a parallelogrammatic component in the scanning type exposure apparatus, and at least one of a trapezoidal component and an axially symmetrical image distortion component in the stationary type exposure apparatus.

Also, in the sixth exposure method according to the present invention, in the case in which one of the first and second exposure apparatus is a stationary type exposure apparatus and the other is a scanning type exposure apparatus, exposure may be performed with the one exposure apparatus of the first and second exposure apparatus roughly correcting an image distortion component which can be corrected by the other exposure apparatus, and the one exposure apparatus of the first and second exposure apparatus finely correcting an image distortion component which is difficult or impossible to correct by the other exposure apparatus. In such a case, the correction residual error may not be reduced to zero, however, the overlay is obviously improved. In this case, it is preferred that the stationary type exposure apparatus roughly corrects at least one image distortion component of a rectangular component and parallelogrammatic component, and finely corrects at least one image distortion component of a trapezoidal component and an axially symmetrical image distortion component. In this case, the axially symmetrical image distortion component is corrected by the stationary type exposure apparatus, in consideration of a change in the second mask by illumination. In the scanning type exposure apparatus, the image forming position is determined based on the velocity ratio between the mask and the substrate in the scanning direction. Accordingly, if synchronous control is performed as predetermined for both the mask and the substrate, no systematic image distortion will be generated. In the non-scanning direction, the image distortion is reduced due to averaging during scanning and thus it is inconceivable that an axially symmetrical image distortion component will occur due to aberration of the projection optical system or the like. On the other hand, the axially symmetrical image distortion component that is generated due to a variation in illumination of the mask can be regenerated as it is as the image distortion of the transferred image of the pattern.

Therefore, in the sixth exposure method according to the present invention, where one of the first exposure apparatus and second exposure apparatus is a stationary type exposure apparatus and the other is a scanning type exposure apparatus, it is preferred that the axially symmetrical image distortion component is corrected by the stationary type exposure apparatus, in consideration of a change in the second mask by illumination.

In the seventh aspect of the present invention, there is provided a first lithographic system of forming patterns of a plurality of layers on a substrate using a plurality of exposure apparatus, which comprises adjusting an image forming characteristic of a first exposure apparatus in the plurality of exposure apparatus to expose one layer, in accordance with information on image distortion correction capability of a second exposure apparatus which is different from the first exposure apparatus, and exposing another layer by using the second exposure apparatus.

According to the system, one exposure apparatus of the plurality of exposure apparatus adjusts its own image forming characteristics upon exposure for a layer in accordance with information about the image distortion correction capability of another exposure apparatus for another layer. Accordingly, in the case in which a plurality of layers are exposed on the substrate, the overlay accuracy can be improved at least between the pattern on the layer which is exposed by the one exposure apparatus and the pattern on the layer which is exposed by another exposure apparatus. This lithographic system is effective especially when one exposure apparatus of a plurality of exposure apparatus has a different image distortion correction capability and the remaining exposure apparatus have a similar image distortion correction capability. This results to improving the general overlay accuracy for all the patterns on the layers.

In this first lithographic system according to the present invention, the second exposure apparatus include at least one of an exposure apparatus used in exposure for a previous layer which is exposed before exposure of the one layer by the one apparatus, and an exposure apparatus used in exposure for a subsequent layer which is exposed after exposure of the one layer by the one apparatus. In this system, the one exposure apparatus adjusts the image forming characteristics of itself upon exposure in accordance with information about the image distortion correction capability of at least one of the exposure apparatus that is used for exposure of the existing layer and the exposure apparatus that is to be used for exposure of the subsequent layer. As a result, an exposure apparatus performs exposure by adjusting its image forming characteristic in accordance with the information on the image correction capability of at least one of the exposure apparatus which is used for exposure of sequential layers, Therefore, the overlay accuracy of the patterns transferred onto the substrate can be improved.

In the case further comprising a host computer for totally controlling the plurality of exposure apparatus, the host computer can provide the first exposure apparatus with correction instructions on an optimum image forming characteristic which has been calculated in accordance with the image distortion characteristic of the second exposure apparatus. In such a case, one of the first exposure apparatus and the second exposure apparatus can be a stationary type exposure apparatus in which a mask and the substrate are almost stationary during exposure, and the other of the first exposure apparatus and the second exposure apparatus is a scanning type exposure apparatus in which a mask and the substrate are moved synchronously during exposure.

In the eighth aspect of the present invention, there is provided a second lithographic system of forming patterns of a plurality of layers on a substrate using a plurality of exposure apparatus comprising a host computer for totally controlling the plurality of exposure apparatus, wherein the host computer respectively selects an exposure apparatus to be used for each layer from the plurality of exposure apparatus in accordance with the image distortion characteristics of each exposure apparatus, and the selected exposure apparatus adjusts its own image forming characteristic at the time of exposure in accordance with correction instructions from the host computer, the instructions on an optimum image forming characteristic of the selected apparatus.

In this system, the host computer selects an exposure apparatus to be used for each layer and sends correction instructions on the optimum image forming characteristic of the selected exposure apparatus. Then, in accordance with the instructions, the selected exposure apparatus adjusts its own image forming characteristic upon exposure. Consequently, it becomes possible to improve the overlay accuracy at an optimum level.

In the ninth aspect of the present invention, there is provided a third lithographic system comprising a first exposure apparatus and a second exposure apparatus, and forming patterns of a plurality of layers on a substrate using each of the exposure apparatus, wherein the first exposure apparatus adjusts its own image forming characteristic, in consideration of an image distortion correction capability of the second exposure apparatus, and the second exposure apparatus adjusts its own image forming characteristic, in consideration of an image distortion correction capability of the first exposure apparatus.

In this system, the first exposure apparatus and the second exposure apparatus performs exposure with the image forming characteristics adjusted in consideration of the image distortion correction capability of the exposure apparatus other than itself. Accordingly, regardless of the sequence of the exposure apparatus, the general overlay accuracy can be improved for the patterns that are formed on the substrate.

In the third lithographic system according to the present invention, one of the first and second exposure apparatus can be a stationary type exposure apparatus in which a mask and the substrate are almost stationary during exposure, and the other of the first and second exposure apparatus is a scanning type exposure apparatus in which a mask and the substrate are moved synchronously during exposure.

In this case, each of the stationary type exposure apparatus and the scanning type exposure apparatus corrects its own image distortion component, which can be corrected upon exposure. As described above, since the scanning type exposure apparatus and the stationary exposure type exposure apparatus correct different types of image distortions, it becomes possible to improve overlay accuracy by each exposure apparatus correcting image distortions that can easily be corrected by itself, even if the exposure apparatus cannot completely dissolve the distortion after correction. In other words, the image distortion which one exposure apparatus has difficulty to correct can be easily corrected by the other exposure apparatus. The exposure apparatus can leave the image distortion difficult to corrected to the other apparatus, covering up the drawbacks of the other. In addition, in the case a component which can be corrected by the other apparatus becomes large, the result of the overlay is more accurate when the component which cannot be correct by the other apparatus is reduced. In this case, the image distortion component which can be corrected includes at least one of a rectangular component and a parallelogrammatic component in the scanning type exposure apparatus, and at least one of a trapezoidal component and an axially symmetrical image distortion component in the stationary type exposure apparatus.

In the third lithographic system according to the present invention, where one of the first exposure apparatus and the second exposure apparatus is a stationary type exposure apparatus and the other is a scanning type exposure apparatus, the one exposure apparatus of the stationary type and scanning type exposure apparatus can roughly correct an image distortion component which can be corrected by the other exposure apparatus, and the one exposure apparatus of the stationary type and scanning type exposure apparatus can finely adjust an image distortion component which is difficult to or impossible to correct by the other apparatus. In such case, the correction residual error may not be reduced to zero, however, the overlay accuracy obviously can be improved. In this case, it is preferred that the stationary type exposure apparatus roughly corrects at least one image distortion components of a rectangular component and a parallelogrammatic component, and finely corrects at least one image distortion component of a trapezoidal component and axially symmetrical image distortion component.

The lithography system according to the first, the second, and the third aspect of the present invention includes a plurality of exposure apparatus, and at least one of the exposure apparatus adjusts its image forming characteristics in consideration of image distortion correction capability of the others. Therefore, according to a tenth aspect, the present invention is an exposure apparatus which exposes a substrate with an energy beam and transfers a predetermined pattern onto the substrate, comprising a substrate stage for holding the substrate, an optical system through which the energy beam passes, an image forming characteristics correction mechanism for correcting a pattern image distortion which is transferred onto the substrate by the energy beam via the optical system, and a controller for controlling the image forming characteristics correction mechanism in consideration of an image distortion correction capability of another exposure apparatus used in a series of lithography processes.

According to this exposure apparatus, the controller corrects (adjusts) the image distortion of the pattern to be transferred onto the substrate with the energy beam that has passed through the optical system via the image forming characteristics correction mechanism, in consideration of the image distortion correction capability of the other exposure apparatus that are used in a series of lithographic processes. As a result, in the case a plurality of layers are exposed above one another on the substrate, the overlay accuracy can be improved at least between the pattern on the layer exposed by the exposure apparatus mentioned above and the patterns on the layer exposed by the other exposure apparatus mentioned above.

In this case, the exposure apparatus may further comprise a mask stage to hold a mask, the pattern formed on the mask. In addition, the exposure apparatus may further comprise a driving unit which relatively scans the substrate stage holding the substrate and the mask stage holding the mask in a linear direction against said energy beam, wherein the controller further controls at least one of a relative scanning velocity ratio and an angle between scanning directions of the substrate stage and the mask stage through the driving unit, in consideration of an image distortion correction capability of the another exposure apparatus.

In the eleventh aspect of the present invention, there is provided a method of making an exposure apparatus in which an energy beam exposes a substrate and transfers a predetermined pattern onto said substrate, which comprises providing a substrate stage for holding the substrate, providing an optical system through which the energy beam passes, providing an image forming characteristics correction mechanism for correcting a pattern image distortion which is transferred onto the substrate by the energy beam via the optical system, and providing a controller for controlling the image forming characteristics correction mechanism in consideration of an image distortion correction capability of another exposure apparatus used in a series of lithography processes. With this method, the exposure apparatus of the present invention can be made by mechanically, optically, and electrically combining and adjusting the substrate stage, the optical system, the image forming characteristics correction mechanism, and the controller, and other various parts.

In this case, the method can further comprise providing a mask stage to hold a mask, the pattern formed on the mask. Then, a stationary type exposure apparatus using the step-and-repeat method or the like can be made.

The method of making an exposure apparatus according to the present invention can further comprise providing a driving unit which scans the mask stage and the substrate stage in a linear direction against the energy beam, wherein the driving unit can change at least one of a relative velocity ratio and an angle between the scanning directions of the mask stage and the substrate stage. In such a case, it is possible to make a scanning type exposure apparatus using the step-and-scanning method or the like, which can correct image distortion characteristics by changing or adjusting the scanning velocity ratio and the angle between the scanning directions of the mask stage and the substrate stage.

In addition, in a lithographic process, a plurality of patterns can be accurately formed on a substrate using an exposure method of the present invention, thereby making the production of highly integrated microdevices with high productivity possible. And in a lithographic process, a plurality of patterns can be accurately formed on a substrate using a lithography system of the present invention, thereby making the production of highly integrated microdevices with high productivity possible. According to still another aspect of the present invention, by using the lithographic system for exposure, highly integrated microdevices with high productivity can be realized.

### BRIEF DESCRIPTION OF THE DRAWINGS

FIG. 1 is a schematic view showing the configuration of the main portion of a lithographic system according to an embodiment of the present invention;

FIG. 2 is a detailed view showing the configuration of an exposure apparatus 20A of FIG. 1;

FIG. 3 is an explanatory view showing the principle of scanning exposure of the exposure apparatus of FIG. 2;

FIGS. 4(A) and (B) are explanatory views showing the capability of correcting for (or generating) image distortion of the exposure apparatus 20B of FIG. 1;

FIGS. 5(A) through (C) are explanatory views showing the capability of correcting for (or generating) image distortion of the exposure apparatus 20A;

FIGS. 6(A) through (D) are explanatory views showing the exposure method of a first case according to the lithographic system of FIG. 1;

FIGS. 7(A) through (D) are explanatory views showing the exposure method of a second case according to the lithographic system of FIG. 1;

FIG. 8 is a flow chart for explaining an embodiment of a device manufacturing method according to the present invention; and

FIG. 9 is a flow chart showing processing in step 204 in FIG. 8.

### DESCRIPTION OF THE PREFERRED EMBODIMENTS

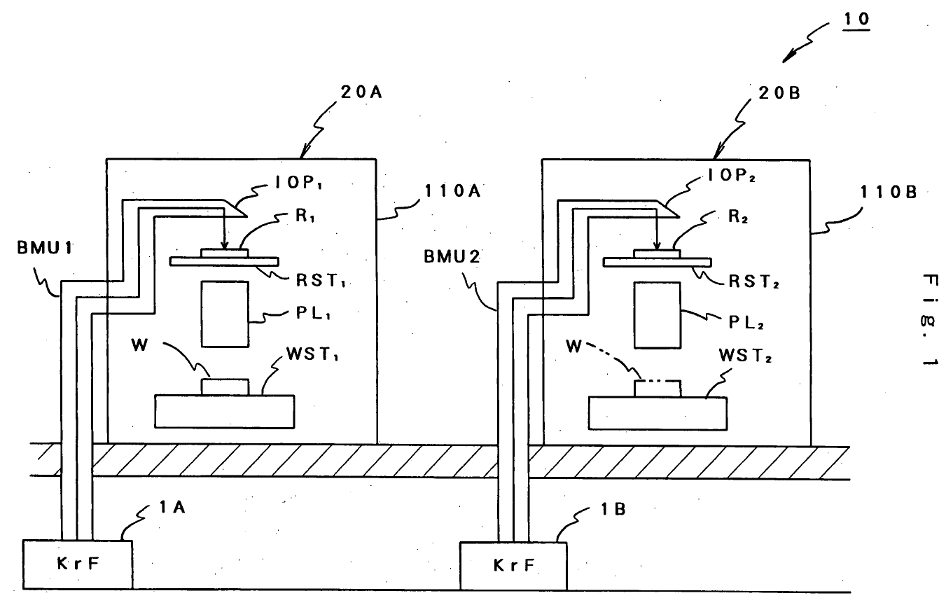

An embodiment of the present invention will be explained below with reference to FIGS. 1 through 7.

FIG. 1 shows schematically the configuration of a lithographic system according to this embodiment. This lithographic system 10 comprises an exposure apparatus 20A with a first chamber 110A and an exposure apparatus 20B with a second chamber 110B.

The exposure apparatus 20A is a scanning projection exposure apparatus (a so-called scanning stepper) based on the step and scan method, while the exposure apparatus 20B is a reduction projection exposure apparatus (a so-called stepper) based on the step and repeat method.

The exposure apparatus 20A comprises an illumination optical system IOP₁, a reticle stage RST₁ for holding a reticle R₁ as a mask, a projection optical system PL₁, and a wafer stage WST₁ on which a wafer W is loaded as a substrate. The illumination optical system IOP₁ is connected via a beam matching unit BMU1 with a KrF excimer laser unit 1A, which is installed in a service room beneath the floor (in the service room with the degree of cleanliness lower than that of the clean room where the exposure apparatuses 20A, 20B are installed).

The exposure apparatus 20B comprises an illumination optical system IOP₂, a reticle stage RST₂ for holding a reticle R₂ as a mask, a projection optical system PL₂, and a wafer stage WST₂ on which a wafer W is loaded as a substrate. The illumination optical system IOP₂ is connected via a beam matching unit BMU2 with a KrF excimer laser unit 1B, which is installed in the service room beneath the floor.

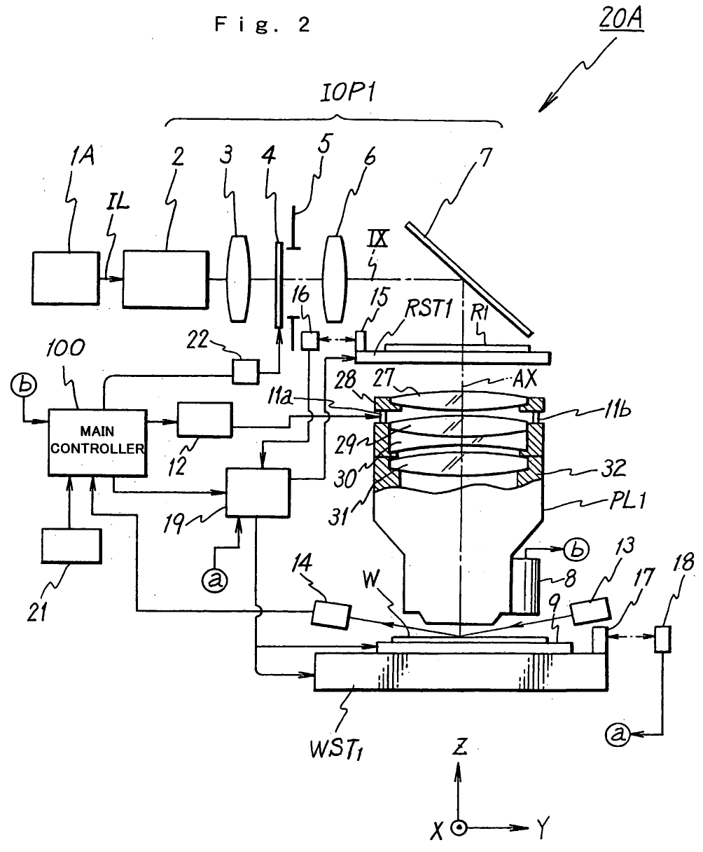

FIG. 2 is a detailed view of the general of the exposure apparatus 20A. The chamber 110A is not illustrated in FIG. 2.

The illumination optical system IOP₁ comprises an illuminant averaging optical system 2 with a collimator lens and a fly-eye lens (both of which are not shown), a relay lens 3, a variable ND filter 4, a reticle blind 5, a relay lens 6, and a dichroic mirror 7.

Each part of the configuration of the illumination optical system IOP₁ is explained as well as its function thereof. A beam of illuminating light (a beam of KrF excimer laser light) IL generated by the excimer laser unit 1A enters the illumination optical system IOP₁ via the beam matching unit BMU1 and is converted into a light flux having a generally uniform illumination distribution by illuminant averaging optical system 2. As the illuminating light IL, for example, a beam of excimer laser light such as ArF excimer laser light and F₂ excimer laser light (of a wavelength of 157 nm), harmonics of the copper vapor laser or the YAG laser, or emission lines (such as g-line or i-line) in the ultraviolet region from an extra-high pressure mercury lamp can be used.

A light flux emitted in the horizontal direction from the illuminant averaging optical system 2 reaches the reticle blind 5 via the relay lens 3. The reticle blind 5 is arranged on a plane optically conjugated with the patterned surface of the reticle R₁ and the surface to be exposed of the wafer W. Moreover, the variable ND filter 4 is in close contact with the reticle blind 5 which is arranged in the relay lens 3 side.

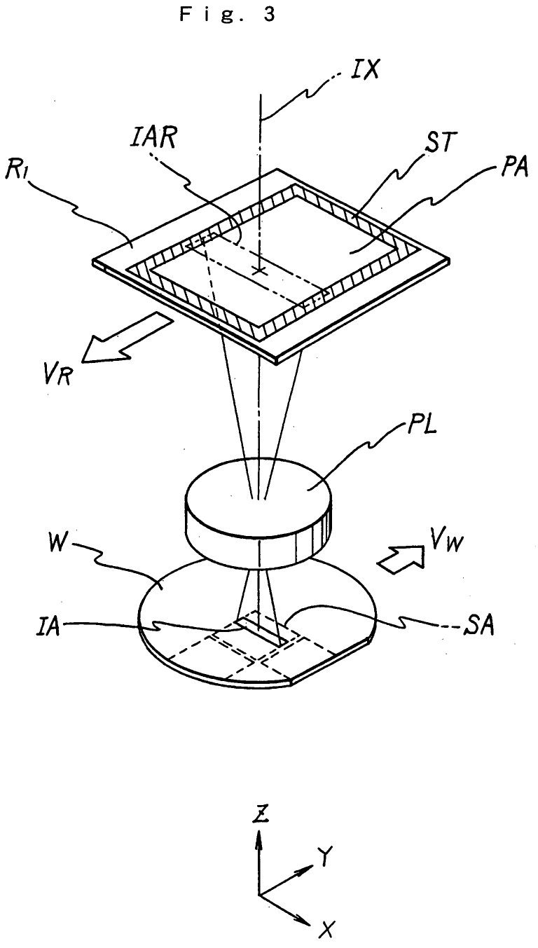

The reticle blind 5 includes a plurality of movable shading plates (for example, two L-shaped movable shading plates). These shading plates are driven by motors, for example. A slit-shaped illumination area IAR (refer to FIG. 3) on the reticle R₁ can be set to a preferred shape and size by adjusting the size of the opening portion (such as the width of the slits) formed by the shading plates.

The variable ND filter 4 set the transmission distribution to a desired state. For example, the variable ND filter 4 has a double slit-array rotor configuration, being comprised of a liquid-crystal display panel, an electrochromic device, or a ND filter which has a desired shape. In this embodiment, the variable ND filter 4 is loaded or unloaded (or the rotational angle thereof is controlled) by a variable ND filter control portion 22. For example, this intentionally makes the illumination distribution within the illumination area IAR on the reticle R₁ non-uniform, and consequently the amount of exposure on the wafer W during scanning can be maintained at a constant level. Typically, the whole variable ND filter 4 is 100% transparent and thus the illumination distribution within the illumination area IAR on the reticle R₁ is uniform.

A light flux that has passed through the variable ND filter 4 and the opening of the reticle blind 5 passes through the relay lens 6 and reaches the dichroic mirror 7, where the light flux is bent vertically downwards and illuminate the illumination area IAR on the reticle R₁ on which circuit patterns and the like are formed.

The reticle R₁ is secured on the reticle stage RST₁, for example, by vacuum chucking. In this case, for positioning the reticle R₁, the reticle stage RST₁ can be finely driven two-dimensionally(in the X-axis direction, in the Y-axis direction perpendicular to the X-axis direction, and in the rotational direction around the Z-axis perpendicular to the X—Y plane), by a reticle stage driving unit (not shown in Figs.) within a plane perpendicular to an optical axis IX (which coincides with the optical axis AX of the projection optical system PL₁ which will be described later) of the illumination optical system comprising a magnetic levitation type two-dimensional linear actuator. The reticle stage RST₁ can also be driven at a specified scanning velocity in the predetermined scanning direction (Y direction in this case). The reticle stage RST, has a movement stroke in the Y direction enough for the whole surface of the reticle R₁ to cross at least the optical axis IX of the illumination optical system. Moreover, in this embodiment, the magnetic levitation type two-dimensional linear actuator includes a X drive coil and a Y drive coil as well as a Z drive coil, and thus can be finely driven even in the Z direction.

A movable mirror 15 for reflecting a laser beam from a reticle laser interferometer (hereinafter referred to as a reticle interferometer) 16 is fixed to the marginal portion of the reticle stage RST₁. The position of the reticle stage RST₁ within the stage movement plane is always detected by the reticle interferometer 16 with a resolution of, for example, about 0.5 to 1 nm. In practice, there is a movable mirror having a reflective surface perpendicular to the scanning direction, and a movable mirror having a reflective surface perpendicular to the non-scanning direction on the reticle stage RST₁. In addition, the reticle interferometer 16 has one measurement axis in the scanning direction and two measurement axes in the non-scanning direction, however, in FIG. 2, the mirrors and the interferometer are respectively shown as the movable mirror 15 and the reticle interferometer 16.

The reticle interferometer 16 sends information of position (or velocity) of the reticle stage RST₁ to a stage control system 19. The stage control system 19 then drives the reticle stage RST₁ through the reticle stage drive unit (not shown in Figs.) based on information about the position (or velocity) of the reticle stage RST₁.

Furthermore, the initial position of the reticle stage RST₁ is determined so that the reticle R₁ is positioned at a predetermined reference position with accuracy by a reticle alignment system (not shown in Figs.). Accordingly, only the position of the movable mirror 15 has to be measured by the reticle interferometer 16 for a high precision measurement.

As shown in FIG. 2, the projection optical system, PL₁ is arranged under the reticle stage RST₁ with the direction of the optical axis AX (coincident with the optical axis IX of the illumination optical system) as the Z-axis direction. In this embodiment, a plurality of lens elements 27, 29, 30, 31, . . . , spaced apart at predetermined intervals in the optical axis AX direction and a lens barrel 32 for holding the lens elements 27, 29, 30, 31, . . . , are arranged to form a double telecentric optical system. The projection optical system PL₁ is a reduction optical system with a predetermined projection magnification, for example, ⅕ (or ¼). Accordingly, when the illumination area IAR (refer to FIG. 3) on the reticle R₁ is illuminated with the illuminating light IL from the illumination optical system IOP₁, the illuminating light IL that passes through the reticle R₁ forms a reduced image (a partial inverted image) of the circuit pattern formed on the illumination area IAR of the reticle R₁ via the projection optical system PL₁ on to the wafer W of which a resist (a photosensitive material) is coated on the surface. The exposure apparatus 20A has an image forming characteristics correction mechanism which corrects distortion of a projected image (including the magnification) caused by the projection optical system PL₁ (the mechanism being described in detail later).

As shown in FIG. 2, the wafer stage WST₁ is arranged under the projection optical system PL₁ and a wafer holder 9 is held on the wafer stage WST₁. The wafer W is held on the wafer holder 9 by vacuumed chucking. The wafer holder 9 can be tilted in a direction with respect to the optimum image forming plane of the projection optical system PL₁ by a driving unit (not shown in Figs.). The wafer holder 9 can be also finely moved in the optical axis AX direction (Z-direction) of the projection optical system PL₁. The wafer holder 9 can also rotate around the optical axis AX.

The wafer stage WST₁ can be moved not only in the scanning direction (in the Y-direction) but also in the direction perpendicular to the scanning direction (in the X-direction) so that a plurality of shot areas on the wafer W can be positioned on a exposure area IA conjugated with the illumination area IAR. Thus, the wafer stage WST₁ performs the step and scan operation in which the operation of scanning exposure to each of the shot areas on the wafer W and the operation for moving to the subsequent shot exposure starting position are repeated. This wafer stage WST₁ is driven in the X—Y two-dimensional direction by a wafer stage driving member (not shown in Figs.) such as a motor.

A movable mirror 17 for reflecting a laser beam from a wafer laser interferometer (hereinafter referred to as the “wafer interferometer”) 18 is fixed on the marginal portion of the wafer stage WST₁. This allows the position of the wafer stage WST₁ on the X—Y plane to be always detected, for example, with a resolution of about 0.5-1 nm by the wafer interferometer 18. In practice, there is a movable mirror with a reflective surface perpendicular to the scanning direction and a movable mirror with a reflective surface perpendicular to the non-scanning direction provided on the wafer stage WST₁. In addition, the wafer interferometer 18 has one measurement axis in the scanning direction and two measurement axes in the non-scanning direction, however, these mirrors and axes are respectively represented as the movable mirror 17 and the wafer interferometer 18 in FIG. 2. Information on the position of the wafer stage WST₁ (or velocity) is sent to the stage control system 19, and the stage control system 19 controls the wafer stage WST₁ based on information regarding the position (or velocity).

As shown in FIG. 3, in the exposure apparatus 20A configured as above, the reticle R₁ is illuminated at the rectangular (or slit-shaped) illumination area IAR which longitudinal direction is perpendicular to the scanning direction (the Y-direction) of the reticle R₁. The reticle R₁ is scanned at velocity V_{R} in the —Y direction at the time of exposure. The illumination area IAR (the center of the area generally coincides with the optical axis AX) is projected onto the wafer W via the projection optical system PL1 and forms a slit-shaped projection area, that is, the exposure area IA. The wafer W has an inverted image forming relationship with the reticle R₁. The wafer W is synchronously scanned at velocity V_{W} with the reticle R₁ in the direction opposite to that of the velocity V_{R} and thus the entire shot areas SA on the wafer W can be exposed. In the case where the ratio of the scanning velocity V_{W}/V_{R} corresponds accurately to the reduction of the projection optical system PL₁, the pattern formed on a pattern area PA of the reticle R₁ is reduced and transferred accurately to the shot areas SA on the wafer W. The longitudinal width of the illumination area IAR is to be wider than the pattern area PA on the reticle R₁ and narrower than the maximum width of an area including a shading area ST, and the whole pattern area PA is to be illuminated by scanning.

Referring back to FIG. 2, an off-axis type alignment microscope is arranged on a side of the projection optical system PL₁, for example, an image forming alignment sensor 8 using an image processing method to detect the position of an alignment mark (wafer mark) conformed to each of the shot areas on the wafer W. The alignment sensor 8 sends the measurement results to a main controller 100 which controls the operation of the whole apparatus. Then, the main controller 100 calculates the arrangement coordinates of the shot area on the wafer W by the statistical computation disclosed in, Japan Patent Laid-Open No. 61-44429 and corresponding U.S. Pat. No. 4,780,617, which are fully incorporated by reference herein, based on the measured positions on the wafer marks. The processing in order to determine the arrangement coordinates of the shot area is hereinafter referred to as the EGA (Enhanced Global Alignment).

Furthermore, in the apparatus shown in FIG. 2, a multiple focal position detecting system using an oblique incident light is fixed to a support member (not shown in Fig.) which supports the projection optical system PL₁. The multiple focal position detecting system comprises an irradiation optical system 13 which sends the image forming light flux, which forms a plurality of slit images on the optimum image forming plane of the projection optical system PL₁ in an oblique direction with respect to the optical axis AX direction. The multiple focal position detecting system also comprises a light-receiving optical system 14 for receiving respective imaging beams reflected on the surface of the wafer W through each slits. As this multiple focal position detecting system (13, 14), a system having an arrangement similar to that disclosed in Japan Patent Laid-Open No. 05-190423 and corresponding U.S. Pat. No. 5,502,311 is used, which are fully incorporated by reference herein. The system is used to detect a deviation in the Z direction with respect to a plurality of image forming planes on the surface of the wafer and drives the wafer holder 9 in the Z-direction and inclines the wafer holder so that the wafer W and the projection optical system PL₁ keep a predetermined distance.

Information on the position of the wafer obtained by the multiple focal position detecting system (13, 14) is sent to the stage control system 19 via the main controller 100. The stage control system 19 drives the wafer holder 9 in the Z direction and inclines the wafer holder 9 based on information regarding the Z position of the wafer.

Following is the image forming characteristics correction mechanism for correcting the image forming characteristics of the projection optical system PL₁. The image forming characteristics correction mechanism corrects the image forming characteristics of the projection optical system PL₁ itself caused by atmospheric changes or illuminating light absorption. The mechanism also distorts a projection image of the pattern on the reticle R₁ to match with the distortion of an exposed shot (a short area) of an existing layer of the wafer W. The image forming characteristics of the projection optical system PL₁ include focus position, field curvature, distortion, astigmatism, and the like. Mechanisms may be available for correcting these characteristics, however, the following descriptions on image forming characteristics correction mechanism refers only to correcting the distortion of projection images (including magnification).

In FIG. 2, a lens element 27, which forms the projection optical system PL₁, nearest to the reticle R₁ is secured to a support member 28, and the lens elements 29, 30, 31, . . . , subsequent to the lens element 27, are secured to the lens barrel 32 of the projection optical system PL₁. The support member 28 is connected to the lens barrel 32 of the projection optical system PL₁ via a plurality of (in this example, three) driving elements, for example, piezoelectric elements 11a, 11b, 11c (however, the piezoelectric element 11c located in the deepest position of the page is not shown in FIG. 2). The driving voltage applied to the driving elements 11a, 11b, 11c is controlled independently by an image forming characteristics control portion 12. This allows the lens element 27 to be inclined with respect to a plane perpendicular to the optical axis AX and moved in the direction of the optical axis. The driving amount of the lens element 27 by each drive element is accurately measured by a position sensor (not shown in Fig.) and the position of the lens element 27 is adapted to be maintained at a target value by servo control.

In this exposure apparatus 20A, the image forming characteristics correction mechanism (which also serves as a magnification adjustment mechanism) comprises the support member 28 of the lens element 27, the driving elements 11a, 11b, 11c, and the image forming characteristics control portion 12 for controlling the driving voltage of the driving elements. Furthermore, the optical axis AX of the projection optical system PL₁ is to be in common with the optical axis of the lens element 29 and those arranged thereunder.

In addition, in the exposure apparatus 20A, an input unit 21 such as a keyboard is connected to the main controller 100.

Next, the configuration and the like of the exposure apparatus 20B are explained briefly. The general configuration of the exposure apparatus 20B is basically the same in principle as that of the exposure apparatus 20A shown in FIG. 2, and thus the detailed configuration is not illustrated. The exposure apparatus 20B is different from the exposure apparatus 20A in that it has a stationary reticle blind with a square opening and that the reticle stage RST₂ has a configuration that allows fine driving within the X-Y plane and in the Z direction. The configuration of other parts is almost the same as that of the exposure apparatus 20A, including the image forming characteristics correction mechanism. In this exposure apparatus 20B, a square pattern area on the reticle R₂ is illuminated with the illuminating light determined by the stationary reticle blind, and the pattern of the reticle R₂ is reduced and projected onto the wafer W in the state that the wafer W is almost stationary. With the exposure apparatus 20B, the illumination area coincides with a shot area on the wafer W. The exposing operation for transferring the pattern of the reticle R₂ onto the wafer W and the step movement of the wafer W to the exposure position for the subsequent shot are performed repeatedly. Thus, the step and repeat method is used to transfer the pattern of the reticle R₂ sequentially onto the wafer W.

In the following descriptions, for components other than those shown in FIG. 1, those related to the exposure apparatus 20A are denoted with a numerical suffix “1” to reference symbols of FIG. 2, while those related to the exposure apparatus 20B are denoted with a numerical suffix “2” to the reference symbols.

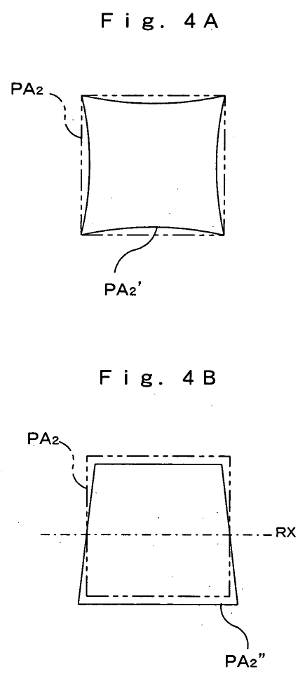

Next, a method for correcting (generating) image distortion of each of the exposure apparatuses is described specifically. First, a method for correcting (generating) image distortion of the exposure apparatus 20B, which is relatively simple, is described with reference to FIGS. 4 (A) and (B).

Similar to the projection optical system PL₁, the exposure apparatus 20B uses the double telecentric projection optical system PL₂. Accordingly, in the case where the lens element 27₂ or the reticle R₂ is driven in parallel to the direction of the optical axis AX of the projection optical system PL₂, an image distortion (which is a magnification component) symmetrical to the optical axis, for example, a symmetrical distortion (pincushion distortion) can be generated which changes the image of a square pattern shown by a dashed-double-dotted line PA₂ in FIG. 4 (A) to an image PA₂′ illustrated by a solid line. In the case, as an optical system PL_{2,} an optical system which is non-telecentric on the reticle side is used, only the magnification can be changed by driving the lens element 27₂ in the direction of the optical axis AX.

Furthermore, in cases where the reticle R₂ or the lens element 27₂ is tilted with respect to a plane perpendicular to the optical axis AX, the square pattern image PA₂ can be changed into a trapezoidal pattern image PA₂″ illustrated by a solid line as shown in FIG. 4 (B), RX being rotational axis when tilted. That is, by changing the magnification component with the axis RX being the center, a trapezoidal distortion can be generated.

Here, as a matter of course, the reticle R₂ may be driven via the Z-drive coil of the magnetic levitation two-dimensional linear actuator. However, when such an actuator is not used, similar to the lens element 27₂, the reticle R₂ may be driven by the three piezoelectric elements which are controlled by the image forming characteristics control portion 12₂. In addition, not only lens element 27₂ but also other lens elements such as lens element 29₂ can be made driven. Alternatively, a group of lenses comprising a plurality of lenses can be made driven.

In general, when an image distortion is generated, the image plane position (focus), the coma aberration, and the like change as side effects. Therefore, it is necessary to drive the reticle R₂ and the lens element 27 to cancel out the effects. To briefly describe the image plane position, the coma aberration, and the distortion as an example, in the case of changing only the distortion without changing the coma aberration, the image forming characteristics of the focus, the coma aberration, and the distortion are each measured to determine the image forming characteristics variation coefficient at the stage of the initial adjustment, while the reticle R₂ and the lens element 27₂ are being driven independently. Then, by using the image forming characteristics variation coefficients mentioned above, excluding the focus, and the driving amount of reticle R₂ and lens element 27₂, simultaneous linear equations (with two unknowns) respecting to the amount of distortion and coma aberration can be made. Then a predetermined value is put into the amount of the distortion and zero is put into the coma aberration. Then, by solving the equations the driving amount of reticle R₂ and lens element 27₂ can be obtained. The reason for excluding the focus in this case, is because when lenses or the like are driven to correct other image forming characteristics such as the distortion, the focus also changes accordingly and thus the focus needs to be corrected by a separate device. The focus can be corrected by changing the target values of the multiple focal position detecting system (13₂, 14₂) which uses the oblique incident light method, in consideration of the change of focus which occurs as a side effect.

As described above, axially symmetrical components or a component that changes proportionally with respect to the distance from an inclined axis can be corrected relatively easily with a stationary type exposure apparatus such as the exposure apparatus 20B, whereas, components such as a rectangular component or parallelogrammatic component (including a rhombic component), are distortions that can hardly be generated since the lens originally is a rotationally symmetrical to the lens axis.

In an attempt to create such distortions method is available in which two pairs of lens elements are polished to provide different curvatures in directions perpendicular to each other, and are rotated respectively related to the other. However, apart from the initial adjustment, it is very difficult to drive the lens elements during exposure which requires a complicated mechanism. Accordingly, it would not be practical to generate (as well as correct) a component by such a method.

The main controller 100₂ of the exposure apparatus 20B receives information which is inputted by the operator through the input unit 21 or at the control system of the exposure apparatus through a communication line. The information is on measured data of the image distortion and data about the image distortion correction capability of at least either the exposure apparatus which performed exposure on the existing layer of the wafer W or the exposure apparatus which is to perform exposure on the subsequent layer at the exposure. In accordance with the data, the main controller 100₂ calculates the optimum driving amount to determine a target value for each of the drive elements (11a₂-11c₂) by the least square method or the inaccuracy error-minimizing method. Alternatively, the target values may also be determined in consideration of not only the image distortion of the exposure apparatus but also the distortion caused during the processing step of the wafer W and errors in reticle patterning.

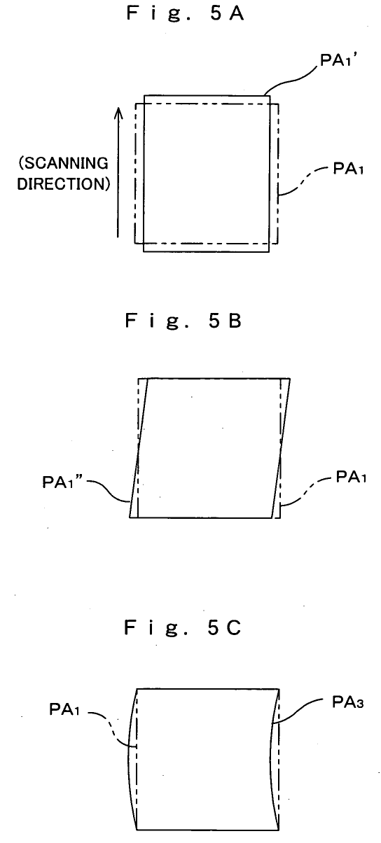

With the exposure apparatus 20A, since patterns are formed after the scanning exposure has been completed, it is meaningless to change only the image shape of the projection optical system PL₁. It is necessary consider the averaging of the image distortion in the scanning direction during scanning. First, the magnification of the projection optical system PL₁ is changed in the same manner as that of the exposure apparatus 20B. It is also necessary to change the scanning velocity ratio (synchronous velocity ratio) between the reticle R₁ and the wafer W. The magnification in the non-scanning direction can be changed by changing that of the projection optical system PL₁, and the magnification in the scanning direction can be changed by changing the synchronous velocity ratio between the reticle R₁ and the wafer W. Therefore, in the main controller 100₁ of the exposure apparatus 20A, it is possible, by changing the magnification of each direction, to generate an image distortion (a rectangular component) in which a square pattern image PA₁ shown by a dashed-double-dotted line in FIG. 5 (A) is changed to a rectangular pattern image PA₁′ shown by a solid line. Furthermore, it is possible by offsetting the angle between the scanning directions of the reticle R₁ and wafer W to generate an image distortion (rhombic or parallelogrammatic image distortion) shown by a solid line PA₁″ of FIG. 5 (B). It is also possible to generate an image distortion shown by a solid line PA₃ in FIG. 5 (C) by changing gradually the angle between the scanning directions of the reticle R₁ and the wafer W during the scanning.

Furthermore, the change of the magnification of the scanning direction by changing the synchronous velocity ratio between the reticle and the wafer and the generation of an image distortion by offsetting the relative angle between the scanning direction of the reticle and that of the wafer are described in detail in Japan Patent Laid-Open No. 06-310399, Japan Patent Laid-Open No. 07-57991, and corresponding U.S. Pat. No. 08/533,923 (Date of application: Sep. 26, 1995), which are fully incorporated by reference herein.

As described above, with the exposure apparatus 20A it is possible to generate an image distortion in the scanning and non-scanning directions independently in order to form the pattern image of the reticle R₁ by the relative scanning (synchronous scanning) between the reticle R₁and the wafer W. In addition, it is possible to generate different image distortions depending on the scanning position, by changing conditions such as the synchronous velocity ratio and the relative angle between the scanning directions, while it is difficult to generate an axially symmetric distortion as shown in FIG. 4 (A), which can be implemented with an exposure apparatus of a stationary type. The trapezoidal image-distortion as shown in FIG. 4 (B) can also be generated by changing the magnification and scanning angle during scanning, but with difficulty because complicated control is required.

The scanning exposure apparatus like the exposure apparatus 20A can expose a large area of an exposure area even with a projection optical system PL₁ having a small effective diameter. Accordingly, this allows the projection optical system PL₁ to have a larger numerical aperture (N.A.), which is suitable for exposure of a fine pattern. Furthermore, the distortion of the projection optical system PL₁ is averaged by scanning the reticle R₁ and the wafer W, providing the effect of averaging the non-uniformity in illuminance. In addition, by performing the focus leveling control (the Z-position and inclination control of the wafer W) in response to the movement of the position of the exposure area IA, a high-accuracy exposure can be performed without being affected too much by waviness of the wafer W. The exposure apparatus is often used for exposure of layers of fine patterns because of the advantages as stated above.

On the other hand, the stationary type exposure apparatus as with the exposure apparatus 20B does not need to scan a reticle or wafer, thus having high productivity (throughput) For this reason, the exposure apparatus is often used particularly for exposure of a layer where no fine line width is required. As described, both type of exposure apparatus can be effectively used in respective layers, depending on the line width the layer requires. For this reason, the stationary type exposure apparatus and the scanning type exposure apparatus are often used in the same device production line, in a so-called mix-and-match manner, and thus, both types of exposure apparatus are used for overlaying and exposing patterns on different layers of the same wafer.

Next, an exposure method of transferring the different patterns of the reticle R₁ and reticle R₂ onto the same wafer by as in the lithographic system 10 according to this embodiment is described.

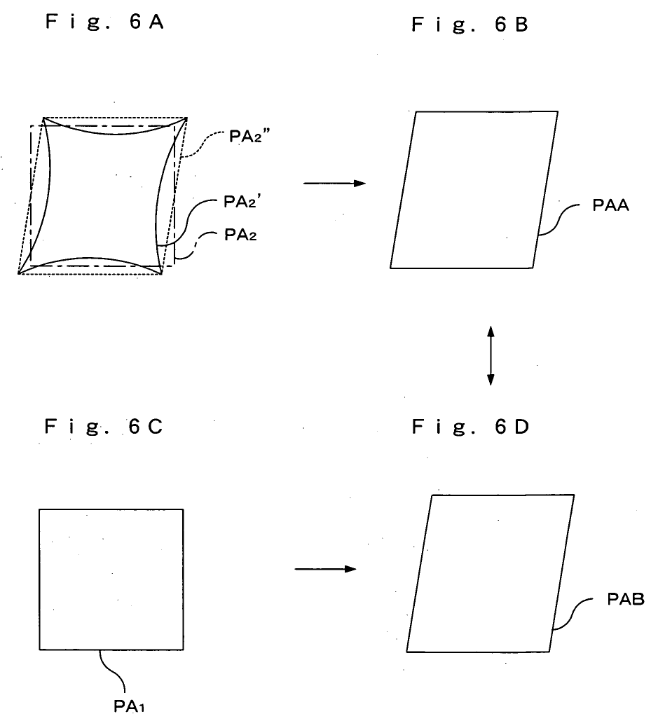

The first case is explained with reference to FIGS. 6 (A) through (D).

FIG. 6 (A) shows an image distortion of the projection optical system PL₂ of the exposure apparatus 20B. The dashed-dotted line PA₂ illustrates the original pattern (a square pattern) of the reticle R₂. The pattern PA₂ without correcting the image forming characteristics would be projected onto the wafer W by the exposure apparatus, in the distorted image shown by the solid line PA₂′. The image distortion PA₂′ is a combination of an image distortion component of a parallelogram shown by a dotted line PA₂″ and the symmetrical distortion (the pincushion distortion of FIG. 4 (A)) component.

FIG. 6 (C) shows the projected image of the projection optical system PL₁ of the exposure apparatus 20A. Referring to FIG. 6 (C), as can be seen, the original pattern (a square pattern) PA₁ of the reticle R₁ is reduced and projected onto the wafer W, with no image distortion. This is because, in a scanning exposure apparatus as with the exposure apparatus 20A, in the scanning direction, the image forming position is determined by the velocity ratio between the reticle and the wafer. Accordingly, if the synchronous control of the reticle stage RST₁ and the wafer stage WST₁ is performed as is predetermined, no systematic image distortion is generated. And also in the non-scanning direction the image distortion is averaged and thus reduced during scanning.

Following is the case in which the pattern of the reticle R₂ as the first mask is transferred onto a shot area on a layer (for example, the first layer) on the wafer W using the exposure apparatus 20B as the first exposure apparatus, and then the pattern of the reticle R₁ as the second mask is transferred on top of each shot area on a subsequent layer on the wafer W, which already holds the pattern of the reticle R₂, using the exposure apparatus 20A as the second exposure apparatus.

First, the main controller 100₂ of the exposure apparatus 20B adjusts its image forming characteristics so that only the symmetrical distortion which can be easily (possibly) corrected by itself is corrected. This adjustment is performed in accordance with the information on the image forming characteristics correction capability of the exposure apparatus 20A, which information is inputted previously via the input unit 21₂ by the operator and stored in the memory device, and in consideration of the fact that the exposure apparatus 20A can easily generate the image distortion component of a parallelogrammatic component, and the main controller 100₂ drives at least either the lens element 27₂ or the reticle stage RST₂ in a predetermined amount along the optical axis direction. When the adjustment is completed, the pattern PA₂ of the reticle R₂ is transferred onto the wafer W in a step-and-repeat manner sequentially, thus forming a parallelogrammatic pattern image PAA (and the image of alignment marks which are not shown), as shown in FIG. 6 (B), on each shot area on the wafer W. The wafer W is, then, unloaded from the exposure apparatus 20A and the process such as development and resist coating is performed by a coater/developer (not shown in Figs.).

Next, the wafer W which has the parallelogrammatic shot areas formed, is loaded onto the wafer stage WST₁ of the exposure apparatus 20A, and the measurement of the wafer marks and EGA or the like are performed by the alignment sensor 8₁. The step-and-scan exposure is repeated, and the pattern of the reticle R₁ is overlaid and transferred onto each shot area (the parallelogrammatic pattern area) on the wafer W. Upon transferring the pattern of the reticle R₁, the main controller 100₁ of the exposure apparatus 20A performs scanning exposure with the angle between the scanning direction of reticle stage RST₁ and the wafer stage WST₁ being set as a predetermined angle so that the pattern image PAB which includes a parallelogrammatic image distortion, as shown in FIG. 6 (D) is transferred. The main controller 100, of the exposure apparatus 20A calculates the parallelogrammatic component mentioned above, in accordance with data on the image forming characteristics correction capability of the exposure apparatus 20B, which data is inputted via the input unit 21₁ by the operator (or inputted from the exposure apparatus 20B through a communication line). The main controller 100₁ then sets the angle between the scanning direction of the reticle stage RST₁ and the wafer stage WST₁ considering the parallelogrammatic component, and controls the angle between the scanning direction of the wafer W and reticle R₁ with respect to the scanning direction of the reticle R₁ via the stage control system 19, thus adjusting the image forming characteristics of the exposure apparatus 20A.

In the case that the main controller 100₁ of the exposure apparatus performs the EGA which is previously mentioned, as is disclosed in the previously mentioned Japan Patent Laid-Open No. 07-57991 and corresponding U.S. Pat. No. 08/533,923, as well as the arrangement direction of the shot area on the wafer W, information on the shape of each of the shot area can be gathered. In accordance with this information, the main controller 100₁ also calculates the angle between the scanning direction of the reticle R₁ and the conjugated direction, and supplies the information about the angle to the stage control system 19₁, thus, making it possible to control the angle between the scanning direction of the reticle R₁ and the scanning direction of the wafer W via the stage control system 19₁.

As can be seen clearly from the comparison of FIG. 6 (B) with FIG. 6 (D), this allows the projection image of the pattern of the reticle R₁ to be transferred almost overlapping each shot area where the transferred image of the pattern of the reticle R₂ on the wafer W is formed. As described above, by performing exposure with the exposure apparatus 20B considering the image distortion correction capability of the other exposure apparatus or the exposure apparatus 20A and adjusting its image forming characteristics so that the image distortion, which the other exposure apparatus can easily generate and the exposure apparatus itself (self-exposure apparatus) corrects with difficulty, remains, and with the other exposure apparatus 20A generating the image distortion easy to generate, in accordance with at least either the data on the image distortion correction capability of the exposure apparatus 20B or the alignment measurement results, overlay precise accuracy can be achieved to such an extent that correction residual error is substantially equal to zero.

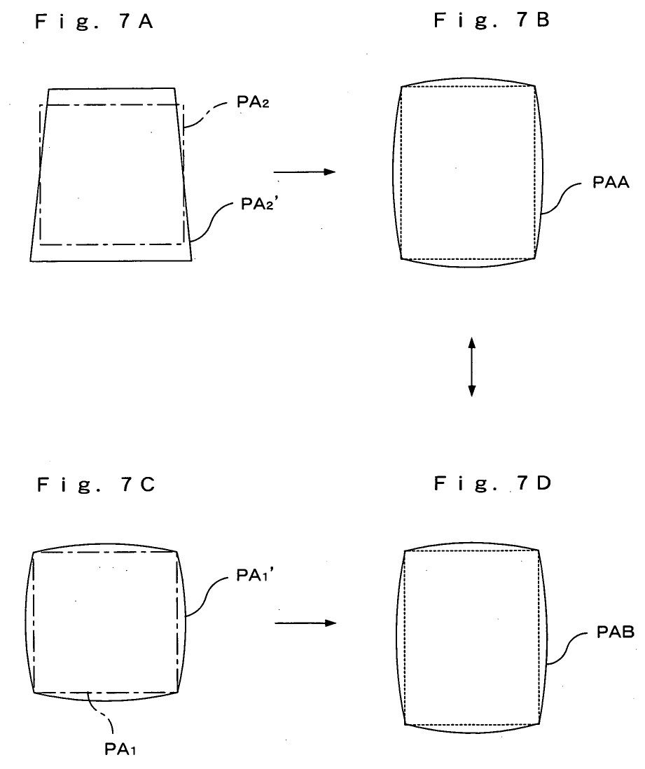

FIG. 7 (A) through (D) describes a second case. FIG. 7 (A) shows the image distortion of the projection optical system PL₂ of the exposure apparatus 20B. The dashed-dotted line PA₂ indicates the projection image of the original pattern (a square pattern) of the reticle R₂. The solid line PA₂′ is the pattern to be projected onto the wafer W using the exposure apparatus 20B, without correcting the image forming characteristics, therefore having the image distortion. The image distortion of the projection image PA₂′ includes a rectangular component and a trapezoidal component.

FIG. 7 (C) shows the projected image of the projection optical system PL₁ of the exposure apparatus 20A. In FIG. 7 (C), a projected image of the original pattern (a square pattern) of the reticle R₁ is indicated by the dashed-dotted line PA₁. Projecting the pattern PA₁ onto the wafer W with the exposure apparatus 20B without correcting the image forming characteristics generates a symmetrical distortion (a barrel type distortion) shown by the solid line PA₂. In this case, it is not the projection optical system PL₁ but the reticle R₁ that absorbs the illuminating light and expands generating the symmetrical distortion. As described above, in a scanning type exposure apparatus like the exposure apparatus 20A, if the synchronous control of the reticle stage and the wafer stage is performed as is predetermined, no systematic image distortion is generated in the scanning direction, and also in the non-scanning direction, the image distortion is averaged and thus reduced during scanning. The change in the reticle R₁ is not affected by the averaging effect of the scanning, thus image distortion is generated as is shown in FIG. 7 (C).

Following is the case in which the pattern of the reticle R₂ as the first mask is transferred onto a shot area on a layer (for example, the first layer) on the wafer W using the exposure apparatus 20B as the first exposure apparatus, and then, the pattern of the reticle R₁ as the second mask is transferred on top of each shot area on the subsequent layer on the wafer W which already holds a transferred pattern of the reticle R₂, using the exposure apparatus 20A as the second exposure apparatus.

First, the main controller 100₂ of the exposure apparatus 20B adjusts its image forming characteristics so that it positively generates the symmetric distortion which the exposure apparatus 20B is expected to generate. This adjustment is performed in accordance with the information on the image forming characteristics correction capability of the exposure apparatus 20A, which information is inputted in advance via the input unit 21 by the operator and stored in the memory device, and in consideration of the fact that the exposure apparatus 20A can easily generate a rectangular image distortion component and also generates a symmetrical distortion (barrel type distortion). In order to perform such adjustment, for example, the lens element 27₂ is rotated about the X-axis perpendicular to the optical axis AX by in predetermined angle, and at least one of the reticle R₂ and the lens element 27₂ is driven in the Z direction. When the adjustment is completed, the pattern of the reticle R₂ is transferred onto the wafer W in a step-and-repeat manner sequentially, thus forming a rectangular pattern image PAA (and the image of alignment marks which are not shown) including the barrel type distortion as shown in FIG. 7 (B) on each shot area on the wafer W. The wafer W is, then, unloaded from the exposure apparatus 20B and the process such as development and resist coating is performed by a coater/developer (not shown) or the like.

Next, the wafer W which has the rectangular shot areas including the barrel type distortion component formed, is loaded onto the wafer stage WST₁ of the exposure apparatus 20A, and the measurement of the wafer marks and EGA or the like are performed by the alignment sensor 8₁. The step-and-scan manner exposure is repeated, and the pattern of the reticle R₁ is overlaid and transferred onto each shot area (the rectangular pattern area including the barrel distortion component) on the wafer W. Prior to transferring the pattern of the reticle R₁, the main controller 100₁ of the exposure apparatus 20A gives judgement to the following items, in accordance with information on the image forming characteristics correction capability of the exposure apparatus 20B which has performed the exposure of the pattern on the existing layer of the wafer W, the information being inputted by the operator in advance in the memory device via the input unit 21. In this case the main controller 100₁ judges whether a rectangular component which is difficult for the exposure apparatus 20B to correct has been generated as the image distortion of the exposure apparatus 20B, the symmetrical distortion which is generated by the exposure apparatus 20A itself is difficult to correct (with a scanning type exposure apparatus, an axially symmetrical image distortion cannot be corrected due to the averaging effect even by driving lens elements or the like), and the exposure apparatus 20B can easily generate symmetrical distortion that is difficult to correct with the exposure apparatus 20A.

The main controller 100₁, then, performs scanning exposure, based on the judgement mentioned above with the image forming characteristics adjusted to the rectangular component, in other words, the magnification in the scanning direction is changed. The change of magnification is performed by controlling the synchronous velocity ratio of the reticle R₁ and the wafer W via the stage control system 19₁.

In this manner, the rectangular pattern image PAB including the barrel type distortion as shown in FIG. 7 (D) can be transferred onto each shot area on the wafer W. The comparison of FIG. 7 (B) with FIG. 7 (D) clearly shows that the pattern of the reticle R₁ to be transferred onto each shot area matches with the pattern of the reticle R₂ on the wafer W, by both exposure apparatus 20A and 20B using information on the image distortion correction capability of the other exposure apparatus, and positively generating an image distortion component that is difficult for the other exposure apparatus to generate but easy for the exposure apparatus itself to generate. It is, therefore possible to decrease the correction residual error almost equal to zero and thus perform exposure with a highly accurate overlay. In the case, the image distortion component include a distortion component that is corrected by the other exposure apparatus with difficulty but can easily be corrected by the exposure apparatus itself, it is to be corrected.

However, the reticle expansion value is not fixed, and changes as exposure is performed. Thus, it is desirable to control the amount of the barrel type distortion, which is to be generated by the exposure apparatus 20B, in accordance with information on the accumulated amount of the exposure.

In the second case described above, the order of the exposure apparatuses which transfer the patterns onto the wafer W can be changed, as a matter of course. That is, the pattern of the reticle R₁ as the first mask is transferred onto the wafer W using the exposure apparatus 20A as the first exposure apparatus. Then, the pattern of the reticle R₂ as the second mask is transferred on the wafer W on top of the pattern of the reticle R₁ already transferred, using the exposure apparatus 20B as the second exposure apparatus. In this case, as well, exposure with a highly accurate overlay as described above can be performed by either the exposure apparatus 20A or 20B, considering the image distortion correction capability of the exposure apparatus 20B or 20A, which is used for exposure of the subsequent or the existing layer, and can transfer the patterns with the image forming characteristics corrected.

The forms of image distortions that can be generated in each of the exposure apparatuses are summarized as follows. In a stationary exposure apparatus as with the exposure apparatus 20B, it generates; image distortion components which the exposure apparatus itself can easily generate (correct), for example, magnification, trapezoidal and symmetrical distortion, components which the exposure apparatus itself corrects with difficulty and can be corrected only by a scanning exposure apparatus as in the exposure apparatus 20A (for example, rectangular and parallelogrammatice), and components which both type of the exposure apparatus cannot correct (for example, random component). With a scanning type exposure apparatus like the exposure apparatus 20A, components caused by the projection optical system are usually only in the non-scanning direction. Therefore, distortion which is difficult to correct by the exposure apparatus itself, such as the symmetrical distortion, is not generated, and only image distortion components such as the rectangular component and the parallelogrammatic component is generated, thus, in most cases, the scanning type exposure apparatus can correct these components itself. For this reason, normally, the scanning type exposure apparatus adjusts its component, to a correction residual error which remains after the image forming characteristics of a stationary type exposure apparatus is corrected. As in the second case mentioned above, however, where a component caused by a reticle is generated with the scanning type exposure apparatus, such a component can only be corrected by the stationary type exposure apparatus and thus each exposure apparatus needs to correct the component of the other apparatus.

According to the lithographic system and the exposure method in this embodiment described above, the exposure apparatus 20A which is a scanning type exposure apparatus and the exposure apparatus 20B which is a stationary type exposure apparatus each considers information on image distortion correction capability of its counterpart and corrects (or generates) image distortion components which can be easily corrected (or generated), with respect to each other. It is therefore possible to make the image distortion shape match with each other. Consequently, such correction residual errors which were difficult to correct can be reduced, thus providing improved overlay accuracy.

Furthermore, in the previous descriptions, although the case, in which the main controllers 100 of the exposure apparatus 20A and the exposure apparatus 20B consider information on the image distortion correction capability of the counterpart exposure apparatus and adjust the image forming characteristics at exposure, is described, as a matter of course, the image distortion characteristics of a plurality of exposure apparatuses used to form the patterns of a plurality of layers on a substrate may each be calculated in advance, and a host computer which controls the whole lithographic system may send instructions to each exposure apparatus on exposure for each layer for correcting the image forming characteristics to an optimum (or the minimum error) level. These instructions sent are in accordance with the image forming characteristics of the exposure apparatus used just before and the exposure apparatus to be used right after the exposure of the apparatus receiving the instructions. The host computer which controls the whole lithographic system including a plurality of exposure apparatuses that used to form the patterns of a plurality of layers on a substrate can also select the optimum exposure apparatus to be used for each layer in accordance with the image distortion characteristics of each exposure apparatus, and provide the optimum instructions for correcting the image forming characteristics of the exposure apparatuses. In this case, the weighting may be decided in respect to the degree of line width control required by each layer. In the case of a host computer controlling the whole lithographic system including a plurality of exposure apparatuses, is disclosed in, for example, Japan Patent Laid-Open No. 04-305913 and corresponding U.S. Pat. No. 5,243,377, which are fully incorporated by reference herein.

Furthermore, in the previous descriptions, although the case in which the exposure apparatuses 20A, 20B each perform exposure with the image forming characteristics of each exposure apparatus being corrected so as to minimize the overlay error almost equal to zero in accordance with information on the image distortion correction capability of the other exposure apparatus, the present invention, however, is not limited thereto. That is, a stationary type exposure apparatus as with the exposure apparatus 20B and a scanning type exposure apparatus as with the exposure apparatus 20A can transfer the pattern of the reticle R₂ or the reticle R₁ in which the image distortion component that the other exposure apparatus easily corrects or can correct is corrected roughly, and the image distortion component that the other exposure apparatus corrects with difficulty or cannot correct is corrected finely. In such a case, the correction residual error is not almost equal to zero but the overlay accuracy can obviously be improved.

Furthermore, in the previous descriptions, although the case in which a stationary type exposure apparatus and a scanning type exposure apparatus are coupled to transfer patterns of a plurality of layers one above another onto a substrate, the present invention is not limited thereto. For example, in the case of the exposure apparatus both being a stationary type exposure apparatus, one exposure apparatus may be able to generate a symmetrical distortion component but cannot generate a trapezoidal component, while the other exposure apparatus may be able to generate both the symmetrical distortion and trapezoidal components. In such a case, the technical scope of the present invention, that is, considering the image distortion correction capability of the exposure apparatus other than itself when adjusting the image forming characteristics can be implemented.

Furthermore, the exposure apparatuses 20A, 20B described in this embodiment can be made as follows. That is, the illumination optical system comprising a plurality of lenses and the projection optical system (which driving elements comprising the image forming correction mechanism are incorporated in advance) are incorporated into the main body of the exposure apparatuses which are in turn optically adjusted. Then, the reticle stage and wafer stage, which comprise a large number of mechanical parts, are mounted to the main body of the exposure apparatuses, and wires and pipes are connected. Then, connections are made to each portion of the control systems such as the image forming characteristics control portion and the main controller. Then, overall adjustment (such as electrical adjustment and operation check) is performed. Such exposure apparatus is preferably made in a clean room, where conditions such as temperature and degree of cleanliness are controlled.

Furthermore, the exposure apparatus is not limited to exposure apparatuses for manufacturing semiconductor devices. For example, the present invention can be widely adopted to an exposure apparatus for liquid crystal devices for transferring liquid crystal display element patterns onto a rectangular glass plate or to an exposure apparatus for manufacturing thin-film magnetic heads.

The light beam for exposure (an energy beam) is also not limited to only the g-line (436 nm in wavelength), the i-line (365 nm in wavelength), the KrF excimer laser light (248 nm in wavelength), the ArF excimer laser light (193 nm in wavelength), and F₂ laser light (157 nm in wavelength), but also extreme ultraviolet light (EUV light) which is 5 to 15 nm in wavelength, the X-ray, or the charged particle beams such as the electron beam may be used.

The magnification of the projection optical system is not limited only to a reduction system but also may be an equimagnification system or a magnification system. For the projection optical system, in the case of using the excimer laser, quartz or fluorite may be used as the glass material. In the case of using EUV light or the X-ray, a reflective optical system may be used (a reflective type reticle can also be used). In addition, in the case of using the electron beam, an electron lens (an electromagnetic lens or electrostatic lens) and an electro-optical system comprising a deflector may be used as the optical system. In such case, as a matter of course, the path of electron beam is to be evacuated.

<<Device Manufacturing Method>>

A device manufacturing method using the above exposure apparatus and method in a lithographic process will be described in detail next.

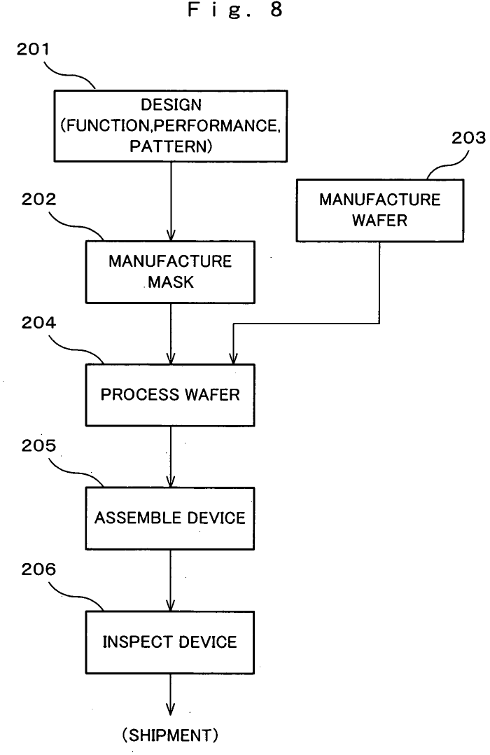

FIG. 8 is a flow chart showing an example of manufacturing a device (a semiconductor chip such as an IC or LSI, a liquid crystal panel, a CCD, a thin magnetic head, a micromachine, or the like). As shown in FIG. 8, in step 201 (design step), function/performance is designed for a device (e.g., circuit design for a semiconductor device) and a pattern to implement the function is designed. In step 202 (mask manufacturing step), a mask on which the designed circuit pattern is formed is manufactured. In step 203 (wafer manufacturing step), a wafer is manufacturing by using a silicon material or the like.

In step 204 (wafer processing step), an actual circuit and the like are formed on the wafer by lithography or the like using the mask and wafer prepared in steps 201 to 203, as will be described later. In step 205 (device assembly step), a device is assembled by using the wafer processed in step 204. Step 205 includes processes such as dicing, bonding, and packaging (chip encapsulation).

Finally, in step 206 (inspection step), a test on the operation of the device, durability test, and the like are performed. After these steps, the device is completed and shipped out.

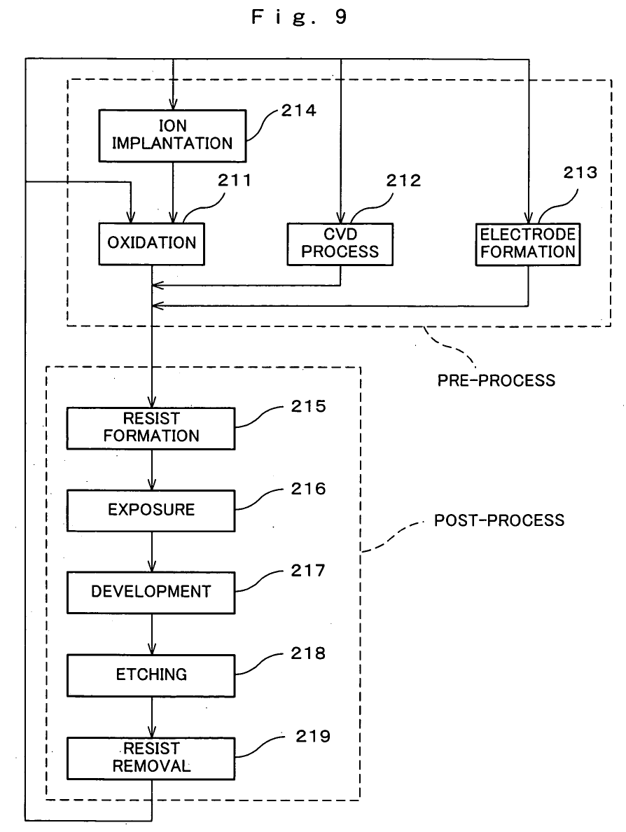

FIG. 9 is a flow chart showing a detailed example of step 204 described above in manufacturing the semiconductor device. Referring to FIG. 9, in step 211 (oxidation step), the surface of the wafer is oxidized. In step 212 (CVD step), an insulating film is formed on the wafer surface. In step 213 (electrode formation step), an electrode is formed on the wafer by vapor deposition. In step 214 (ion implantation step), ions are. implanted into the wafer. Steps 211 to 214 described above constitute a pre-process for the respective steps in the wafer process and are selectively executed in accordance with the processing required in the respective steps.

When the above pre-process is completed in the respective steps in the wafer process, a post-process is executed as follows. In this post-process, first, in step 215 (resist formation step), the wafer is coated with a photosensitive agent. Next, as in step 216, the circuit pattern on the mask is transcribed onto the wafer by the above exposure apparatus and method. Then, in step 217 (developing step), the exposed wafer is developed. In step 218 (etching step), an exposed member on a portion other than a portion where the resist is left is removed by etching. Finally, in step 219 (resist removing step), the unnecessary resist after the etching is removed.

By repeatedly performing these pre-process and post-process, multiple circuit patterns are formed on the wafer.

As described above, by using the device manufacturing method of this embodiment, the exposure apparatus and method of the lithography system 10 and embodiment previously mentioned are used in the exposure step (step 216). This makes it possible to manufacture high-integration microdevices with high productivity (high yield).

The lithography system and the exposure method, previously referred, according to the present invention are suitable for forming fine patterns of a plurality of layers one above another on a substrate such as a wafer with accuracy in the lithographic process for manufacturing micro devices such as integrated circuits.

Furthermore, the device manufacturing method according to the present invention is suitable for manufacturing devices with fine patterns.

While the above-described embodiments of the present invention are the presently preferred embodiments thereof, those skilled in the art of lithography systems will readily recognize that numerous additions, modifications and substitutions may be made to the above-described embodiments without departing from the spirit and scope thereof. It is intended that all such modifications, additions and substitutions fall within the scope of the present invention, which is best defined by the claims appended below.

What is claimed is:

1. An exposure method of forming patterns of a plurality of layers on a substrate using a plurality of exposure apparatus, comprising:
adjusting an image forming characteristic of a first exposure apparatus in said plurality of exposure apparatus to expose one layer in consideration of image distortion correction capability of a second exposure apparatus which is different from said first exposure apparatus; and
exposing another layer by using said second exposure apparatus.

2. The exposure method according to claim 1, wherein said first apparatus is one of a stationary type exposure apparatus in which a mask and said substrate are almost stationary during exposure and a scanning type exposure apparatus in which a mask and said substrate are synchronously moved during exposure, and said second apparatus is the other of the stationary type exposure apparatus and the scanning type exposure apparatus.

3. The exposure method according to claim 2, further comprising:
adjusting an image forming characteristic of the second exposure apparatus in consideration of image distortion correction capability of said first exposure apparatus.

4. The exposure method according to claim 1, wherein said first apparatus and said second apparatus are used in said exposure of layers in sequence.

5. The exposure method according to claim 4, wherein said first apparatus includes one of a stationary type exposure apparatus in which a mask and said substrate are almost stationary during exposure and a scanning type exposure apparatus in which a mask and said substrate are synchronously moved during exposure, and said second apparatus includes the other of the stationary type exposure apparatus and the scanning type exposure apparatus.

6. An exposure method of transferring a pattern of a second mask onto a substrate using a second exposure apparatus after transferring a pattern of a first mask onto said substrate using a first exposure apparatus, the method comprising:
adjusting an image forming characteristic of said second exposure apparatus, in consideration of an image distortion which is difficult or impossible to be corrected by said first exposure apparatus; and
exposing said substrate to transfer the pattern of said second mask by using said second exposure apparatus.

7. An exposure method of transferring a pattern of a first mask onto a substrate using a first exposure apparatus before transferring a pattern of a second mask onto said substrate using a second exposure apparatus, the method comprising:
adjusting an image forming characteristic of said first exposure apparatus, in consideration of an image distortion which is difficult or impossible to be corrected by said second exposure apparatus; and
exposing said substrate to transfer the pattern of said first mask by using said first exposure apparatus.

8. The exposure method according to claim 7, wherein
said second exposure apparatus is a scanning type exposure apparatus which moves said mask and said substrate synchronously during exposure, and
said image forming characteristic of said first exposure apparatus is adjusted so as to reduce an axially symmetrical image distortion component which is difficult or impossible to be corrected by said scanning type exposure apparatus.

9. The exposure method according to claim 7, wherein
said second exposure apparatus is a stationary type exposure apparatus in which said mask and said substrate are almost stationary during exposure, and
said image forming characteristic of said first exposure apparatus is adjusted so as to reduce an image distortion including a rectangular component and parallelogrammatic component, which is difficult or impossible to be corrected by said stationary type exposure apparatus.

10. An exposure method of transferring a pattern of a first mask onto a substrate using a first exposure apparatus, and of further transferring a pattern of a second mask onto said substrate using a second exposure apparatus, said method comprising:
adjusting an image forming characteristic of said first exposure apparatus, in accordance with information on an image distortion correction capability of said second exposure apparatus; and
transferring said pattern of said first mask onto said substrate.

11. The exposure method according to claim 10, wherein said image forming characteristic of said first exposure apparatus is adjusted so as to reduce an image distortion which is difficult or impossible to be correct by said second exposure apparatus.

12. An exposure method of transferring a pattern of a first mask onto a substrate using a first exposure apparatus, and of further transferring a pattern of a second mask onto said substrate using a second exposure apparatus, said method comprising:
adjusting an image forming characteristic of said first exposure apparatus so as to leave an image distortion, which said second exposure apparatus can correct; and
transferring said pattern of said first mask onto said substrate.

13. The exposure method according to claim 12, wherein said second exposure apparatus is a scanning type exposure apparatus which moves said mask and said substrate synchronously during exposure, and
said image forming characteristic of said first exposure apparatus is adjusted so as to leave at least one of image distortion components of a rectangular component and a parallelogrammatic component, which can be corrected by said scanning type exposure apparatus.

14. The exposure method according to claim 12, wherein
said second exposure apparatus is a stationary type exposure apparatus in which said mask and said substrate are almost stationary during exposure, and
said image forming characteristic of said first exposure apparatus is adjusted so as to leave at least one of image distortion components of a trapezoidal component and an axially symmetrical component, which can be corrected by said stationary type exposure apparatus.

15. An exposure method of forming patterns of a plurality of layers on a substrate using a plurality of exposure apparatus, comprising:
transferring a pattern of a first mask onto said substrate using a first exposure apparatus;
adjusting an image forming characteristic of a second exposure apparatus, in accordance with information about image distortion correction capability of said first exposure apparatus; and
further transferring a pattern of a second mask onto an area on said substrate where said pattern of said first mask is formed, using said second exposure apparatus of which said image forming characteristic has already been adjusted.

16. The exposure method according to claim 15, wherein said adjusting image forming characteristic of said second exposure apparatus is performed, further in consideration of information on a shape of a shot area on said substrate, said shape being measured prior to exposure.

17. The exposure method according to claim 15, wherein said transferring said pattern of said first mask is performed in a manner that said pattern of said first mask is transferred onto said substrate with an adjustment of an image forming characteristic of said first exposure apparatus in accordance with image distortion correction capability of said second exposure apparatus.

18. The exposure method according to claim 15, wherein transferring a pattern of a first mask is performed in a manner that said pattern of said first mask is transferred with a correction of an image distortion component which is difficult or impossible to be corrected by said second exposure apparatus.

19. The exposure method according to claim 15, wherein
one of said first and second exposure apparatus is a stationary type exposure apparatus in which said mask and said substrate are almost stationary during exposure, and
the other of said first and second exposure apparatus is a scanning type exposure apparatus in which said mask and said substrate are moved synchronously during exposure.

20. The exposure method according to claim 19, wherein each of said first and second exposure apparatus respectively correct image distortion component which can be corrected.

21. The exposure method according to claim 20, wherein said image distortion component which can be corrected includes
at least one of a rectangular component and a parallelogrammatic component in said scanning type exposure apparatus, and
at least one of a trapezoidal component and an axially symmetrical image distortion component in said stationary type exposure apparatus.

22. The exposure method according to claim 19, wherein
said one exposure apparatus of said first and second exposure apparatus roughly corrects an image distortion component which can be corrected by said other exposure apparatus, and
said one exposure apparatus of said first and second exposure apparatus finely corrects an image distortion component which is difficult or impossible to be corrected by said other exposure apparatus.

23. The exposure method according to claim 22, wherein said stationary type exposure apparatus roughly corrects
at least one image distortion component of a rectangular component and parallelogrammatic component, and finely corrects
at least one image distortion component of a trapezoidal component and an axially symmetrical image distortion component.

24. The exposure method according to claim 21, wherein said axially symmetrical image distortion component is corrected by said stationary type exposure apparatus, in consideration of a change in said second mask by illumination.

25. The exposure method according to claim 23, wherein said axially symmetrical image distortion component is corrected by said stationary type exposure apparatus, in consideration of a change in said second mask by illumination.

26. A lithographic system of forming patterns of a plurality of layers on a substrate using a plurality of exposure apparatus, comprising:
adjusting an image forming characteristic of a first exposure apparatus in said plurality of exposure apparatus to expose one layer, in accordance with information on image distortion correction capability of a second exposure apparatus which is different from said first exposure apparatus; and
exposing another layer by using said second exposure apparatus.

27. The lithographic system according to claim 26, wherein said second exposure apparatus include at least one of
an exposure apparatus used in exposure for a previous layer which is exposed before exposure of said one layer by said one apparatus, and
an exposure apparatus used in exposure for a subsequent layer which is exposed after exposure of said one layer by said one apparatus.

28. The lithographic system according to claim 27, further comprising a host computer for totally controlling said plurality of exposure apparatus, wherein
said host computer provides said first exposure apparatus with correction instructions on an optimum image forming characteristic which has been calculated in accordance with an image distortion characteristic of said second exposure apparatus.

29. The lithographic system according to claim 28, wherein
one of said first exposure apparatus and said second exposure apparatus is a stationary type exposure apparatus in which a mask and said substrate are almost stationary during exposure, and
the other of said first exposure apparatus and said second exposure apparatus is a scanning type exposure apparatus in which a mask and said substrate are moved synchronously during exposure.

30. A lithographic system of forming patterns of a plurality of layers on a substrate using a plurality of exposure apparatus comprising:
a host computer for totally controlling said plurality of exposure apparatus; wherein
said host computer respectively selects an exposure apparatus to be used for each layer from said plurality of exposure apparatus in accordance with the image distortion characteristics of said each exposure apparatus, and
said selected exposure apparatus adjusts its own image forming characteristic at the time of exposure in accordance with correction instructions from said host computer, said instructions on an optimum image forming characteristic of said selected apparatus.

31. A lithographic system comprising a first exposure apparatus and a second exposure apparatus, and forming patterns of a plurality of layers on a substrate using each of said exposure apparatus, wherein
said first exposure apparatus adjusts its own image forming characteristic, in consideration of an image distortion correction capability of said second exposure apparatus, and
said second exposure apparatus adjusts its own image forming characteristic, in consideration of an image distortion correction capability of said first exposure apparatus.

32. The lithographic system according to claim 31, wherein
one of said first and second exposure apparatus is a stationary type exposure apparatus in which a mask and said substrate are almost stationary during exposure, and
the other of said first and second exposure apparatus is a scanning type exposure apparatus in which a mask and said substrate are moved synchronously during exposure.

33. The lithographic system according to claim 32, wherein
each of said stationary type exposure apparatus and said scanning type exposure apparatus corrects its own image distortion component which can be corrected upon exposure.

34. The lithographic system according to claim 33, wherein said image distortion component which can be corrected include
at least one of a rectangular component and a parallelogrammatic component in said scanning type exposure apparatus, and
at least one of a trapezoidal component and an axially symmetrical image distortion component in said stationary type exposure apparatus.

35. The lithographic system according to claim 32, wherein exposure is performed with each of said stationary type exposure apparatus and said scanning type exposure apparatus adjusting image forming characteristics such that
said one exposure apparatus of said stationary type and scanning type exposure apparatus roughly corrects an image distortion component which can be corrected by said other exposure apparatus, and
said one exposure apparatus of said stationary type and scanning type exposure apparatus finely adjusts an image distortion component which is difficult or impossible to be corrected by said other apparatus.

36. The lithographic system according to claim 35, wherein said stationary type exposure apparatus roughly corrects
at least one image distortion components of a rectangular component and a parallelogrammatic component, and finely corrects
at least one image distortion component of a trapezoidal component and axially symmetrical image distortion component.

37. An exposure apparatus which exposes a substrate with an energy beam and transfers a predetermined pattern onto said substrate, comprising:
a substrate stage for holding said substrate;
an optical system through which said energy beam passes;
an image forming characteristic correction mechanism for correcting a pattern image distortion which is transferred onto said substrate by said energy beam via said optical system; and
a controller for controlling said image forming characteristic correction mechanism in consideration of an image distortion correction capability of another exposure apparatus used in a series of lithography processes.

38. The exposure apparatus according to claim 37, which further comprises a mask stage to hold a mask, said pattern formed on said mask.

39. The exposure apparatus according to claim 38, further comprising a driving unit which relatively scans said substrate stage holding said substrate and said mask stage holding said mask in a linear direction against said energy beam, wherein
said controller further controls at least one of a relative scanning velocity ratio and an angle between scanning directions of said substrate stage and said mask stage through said driving unit, in consideration of an image distortion correction capability of said another exposure apparatus.

40. A method of making an exposure apparatus in which an energy beam exposes a substrate and transfers a predetermined pattern onto said substrate, comprising:
providing a substrate stage for holding said substrate,
providing an optical system through which said energy beam passes,
providing an image forming characteristic correction mechanism for correcting a pattern image distortion which is transferred onto said substrate by said energy beam via said optical system; and
providing a controller for controlling said image forming characteristic correction mechanism in consideration of an image distortion correction capability of another exposure apparatus used in a series of lithography processes.

41. The method of making an exposure apparatus according to claim 40, which further comprises providing a mask stage to hold a mask, said pattern formed on said mask.

42. The method of making an exposure apparatus according to claim 41, further comprising:
providing a driving unit which scans said mask stage and said substrate stage in a linear direction against said energy beam, wherein
said driving unit can change at least one of a relative velocity ratio and an angle between said scanning directions of said mask stage and said substrate stage.

43. A device manufacturing method including a lithographic process, wherein
exposure is performed using the method according to claim 1 in said lithographic process.

44. A device manufacturing method including a lithographic process, wherein
exposure is performed using the method according to claim 6 in said lithographic process.

45. A device manufacturing method including a lithographic process, wherein
exposure is performed using the method according to claim 7 in said lithographic process.

46. A device manufacturing method including a lithographic process, wherein
exposure is performed using the method according to claim 10 in said lithographic process.

47. A device manufacturing method including a lithographic process, wherein
exposure is performed using the method according to claim 12 in said lithographic process.

48. A device manufacturing method including a lithographic process, wherein
exposure is performed using the method according to claim 15 in said lithographic process.

49. A device manufacturing method including a lithographic process, wherein
the lithographic system according to claim 26 is used in said lithographic process.

50. A device manufacturing method including a lithographic process, wherein
the lithographic system according to claim 30 is used in said lithographic process.

51. A device manufacturing method including a lithographic process, wherein
the lithographic system according to claim 31 is used in said lithographic process.
